(19) United States
(12) Patent Application Publication
(10) Pub. No.: US 2006/0147649 A1
(43) Pub. Date: Jul. 6, 2006

(54) Photoelectric devices

(75) Inventor: Chung-Chun Lee, Lunbei Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/152,491

(22) Filed: Jun. 14, 2005

(30) Foreign Application Priority Data
Jan. 6, 2005 (TW) 94100375

(51) Int. Cl. C09K 19/00

(52) U.S. Cl. 428/1.1; 428/1.2; 428/1.5

(57) ABSTRACT

A photoelectric device. The photoelectric device includes a set of electrodes having at least two electrodes, and an electron-transporting layer installed between the set of electrodes, wherein the electron-transporting layer comprises an organic bipolar compound having electron/hole mobility exceeding 10⁻⁷ cm²v⁻¹s⁻¹ and a metal-containing material.

### BACKGROUND

The present invention relates to photoelectric devices, and more specifically to an organic electroluminescent device.

Currently, the development of various organic photoelectric devices such as organic solar cells, organic thin film transistors, and organic electroluminescent devices has gained increasing respect in scientific industry. Organic solar cells can directly convert light energy into electrical energy. The advantages of organic solar cells are convenience, quietness, cleanliness, and semi-transparency. They do not need to store energy in advance and can isolate spreading thermal radiation in the environment. Further, organic solar cells have a long lifetime. If combined with building, utility rates thereof may be significantly improved.

Organic materials used in organic thin film transistors (OTFT) have higher extensibility and elasticity than silicon so that an organic thin film transistor can be fabricated on a plastic substrate, such as a flexible display. Compared to a related fabrication method of TFT-LCD similar to the semiconductor fabrication process, an OTFT is fabricated by printing process, such as screen-printing, inkjet-printing, or contact printing. Polymers and amorphous molecules can be widely spin-coated on a substrate to form a semiconductor layer by inkjet-printing with solution and greatly reduce the cost. Additionally, fabrication of OTFT has a fabrication temperature lower than 100° C., TFT-LCD, however, a quite higher temperature of about 200˜400° C. is required.

Organic electroluminescent devices have great potential as products in flat panel display industry due to their high illumination, light weight, self-illumination, low power consumption, simple fabrication, rapid response time, wide viewing angle, and lack of a back light.

When an external electric field is applied to an organic electroluminescent device, electrons and holes are injected respectively into organic electroluminescent layer and then recombined to form excitons. Energy is further transferred from excitons to luminescent molecules by continuously applying electric field. Finally, luminescent molecules emit light converted from energy. A common organic electroluminescent device structure comprises an anode, a hole-transporting layer, an emitting layer, an electron-transport layer, and a cathode. A complex organic electroluminescent device, however, may further comprise a hole-injection layer installed between an anode and a hole-transporting layer, an electron-injection layer installed between a cathode and an electron-transporting layer, or a hole-blocking layer installed between an emitting layer and an electron-transporting layer to improve injection efficiency of carriers, reduce driven voltage or increase recombination thereof.

Conventional Alq₃ electron-transporting layers may easily produce Alq₃⁺ when considerable quantities of holes exist, resulting in deterioration of product lifetime. Additionally, the electron mobility of Alq₃ is inferior to about 10⁻⁷ cm²v⁻¹s⁻¹, causing low electron-transporting capability and luminescent efficiency. Therefore, it is necessary to develop a new electron-transporting material to replace the conventional Alq₃.

### SUMMARY

The invention provides a photoelectric device comprising a set of electrodes having at least two electrodes, and an electron-transporting layer installed between the set of electrodes, wherein the electron-transporting layer comprises an organic bipolar compound having electron/hole mobility exceeding 10⁻⁷ cm²v⁻¹s⁻¹ and a metal-containing material.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross section of an organic light-emitting diode of the invention.

FIG. 2 is a cross section of an organic solar cell of the invention.

FIG. 3 is a cross section of an organic thin film transistor of the invention.

### DETAILED DESCRIPTION

The invention provides a photoelectric device comprising a set of electrodes having at least two electrodes, and an electron-transporting layer installed between the set of electrodes, wherein the electron-transporting layer comprises an organic bipolar compound having electron/hole mobility exceeding 10⁻⁷ cm²v⁻¹s⁻¹ and a metal-containing material.

The electron-transporting layer has a thickness of about 50˜5000 Å. The organic bipolar compound and the material containing metal have a volume ratio of about 0.5:99.5˜99.5:0.5, preferably, 80:20˜50:50.

The organic bipolar compound may be anthracene derivative, fluorene derivative, spirofluorene derivative, pyrene derivative, oligomer, or combination thereof. The anthracene derivative may comprise 9,10-di-(2-naphthyl)anthracene (ADN), 2-(t-butyl)-9,10-di(2-naphthyl)anthracene (TBADN), or 2-methyl-9,10-di(2-naphthyl)anthracene (MADN).

The metal-containing material may be metal, inorganic metal salt, organic metal salt, or combination thereof. The metal comprises alkali metal, alkaline metal, or combination thereof. The inorganic metal salt has a cation comprising Li⁺, Na⁺, K⁺, Cs⁺, Mg²⁺, Ca²⁺, Ba²⁺, or combination thereof and an anion comprising O²⁻, S²⁻, F⁻, Cl⁻, Br⁻, I⁻, NO₃⁻, or combination thereof. The organic metal salt has a cation comprising Li⁺, Na⁺, K⁺, Cs⁺, Mg²⁺, Ca²⁺, Ba²⁺, or combination thereof and an anion comprising aliphatic or aromatic organic anion having carbon atoms less than 30, CO₃²⁻, CH₃COO⁻, or combination thereof.

The invention provides a new electron-transporting layer comprising a bipolar compound having electron/hole mobility exceeding 10⁻⁷ cm²v⁻¹ s⁻¹ and a metal-containing material to greatly improve electrical performance and lifetime of a photoelectric device.

The invention provides a bipolar compound capable of stabilizing electrons and holes to replace a conventional Alq₃ compound in an electron-transporting layer to avoid production of Alq₃⁺, effectively prolonging device lifetime. The operating voltage of a device can also be reduced by adding the described bipolar compound. Additionally, an energy barrier between a cathode and the new electron-transporting layer can be reduced by doping the metal-containing material. Thus, capability of electron injection is significantly increased and luminescent efficiency is improved.

The invention may provide an organic light-emitting diode. A diode further-comprises a hole-injection layer, a hole-transporting layer, an emitting layer, or an electron-injection layer. The hole-injection layer comprises a polymer containing F, C, and H, porphyrin derivative, or p-doped diamine derivative. The porphyrin derivative may comprise metallophthalocyanine derivative, such as copper phthalocyanine.

The hole-transporting layer may comprises diamine derivative, such as N,N′-bis(1-naphyl)-N,N′-diphenyl-1,1′-biphenyl-4,4′-diamine (NPB), N,N′-diphenyl-N,N′-bis(3-methylphenyl)-(1,1′-biphenyl)-4,4′-diamine (TPD), or 2T-NATA. The hole-trahsporting layer has a thickness of about 50˜5000 Å. The emitting layer comprises a single layer or multiple layers comprising fluorescent emitter, phosphorescent emitter, or combination thereof. The emitting layer has a thickness of about 50˜2000 Å. The electron-injection layer may comprise alkali halide, alkaline halide, alkali oxide, or metal carbonate, such as LiF, CsF, NaF, CaF₂, Li₂O, Cs₂O, Na₂O, Li₂CO₃, Cs₂CO₃, or Na₂CO₃. The electron-injection layer has a thickness of about 5˜500 Å.

At least one of the cathode and anode should be a transparent electrode, that is, the cathode and the anode may have the same or different materials, and they may comprise a single layer or multiple layers comprising metal, transparent oxide, or combination thereof. The metal may be Al, Ca, Ag, Ni, Cr, Ti, Mg, or alloy thereof. The transparent oxide may comprises ITO, AZO, ZnO, InN, or SnO₂.

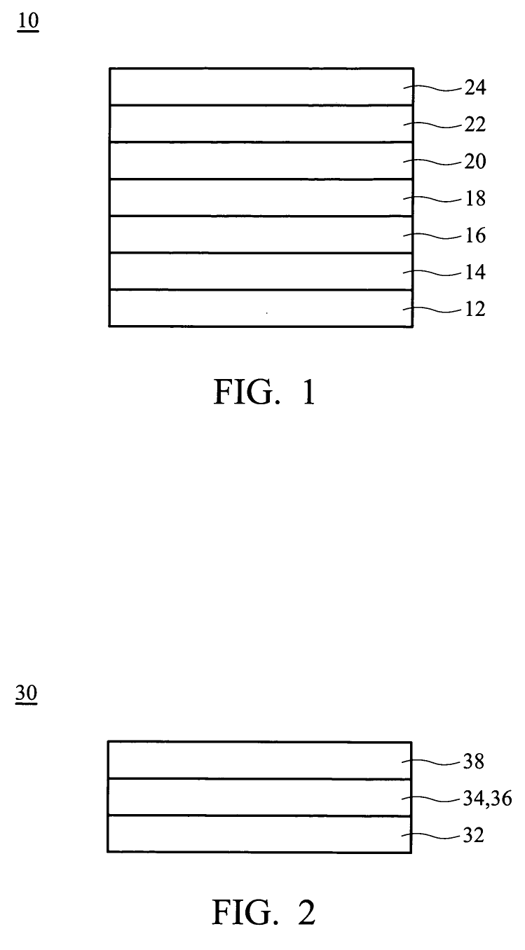

An organic light-emitting diode provided by the invention is disclosed in FIG. 1. The organic light-emitting diode 10 comprises an anode 12, a hole-injection layer 14, a hole-transporting layer 16, an emitting layer 18, an electron-transporting layer 20 comprising an organic bipolar and a metal-containing material, an electron-injection layer 22, and a cathode 24.

The invention may provide an organic solar cell 30 comprising a set of electrodes 32 and 38, an electron-transporting layer 34, and a photoelectric conversion layer 36 installed between the set of electrodes, as shown in FIG. 2.

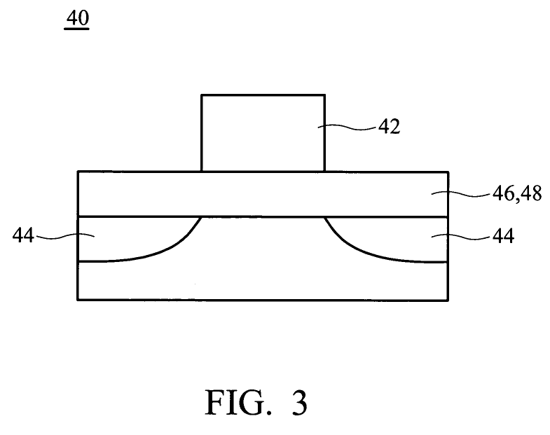

The invention may provide an organic thin film transistor 40 comprising a gate 42, a source/drain 44, an electron-transporting layer 46, and an organic semiconductor layer 48 installed between the gate 42 and the source/drain 44, as shown in FIG. 3.

Referring to FIG. 1, a method of fabricating an organic light-emitting diode is provided. First, an anode 12 is provided. Next, a hole-injection layer 14, a hole-transporting layer 16, an emitting layer 18, an electron-transporting layer 20, an electron-injection layer 22, and a cathode 24 are evaporated on the anode 12 in order. Finally, the diode is packaged to form an organic light-emitting device.

### EXAMPLES

### Comparative Example 1

Referring to FIG. 1, a related method of fabricating an organic light-emitting diode (device A) is disclosed in the following. First, an ITO anode 12 was provided on a substrate. The anode 12 was then treated with UV ozone. Next, copper phthalocyanine was evaporated on the ITO anode 12 to form a hole-injection layer 14. Next, NPB was evaporated on the hole-injection layer 14 to form a hole-transporting layer 16. A green emitting layer 18 was then evaporated on the hole-transporting layer 16. Next, tris(8-hydroxyquinoline)aluminum(III) (Alq₃) was evaporated on the emitting layer 18 to form an electron-transporting layer 20. Next, LiF was evaporated on the electron-transporting layer 20 to form an electron-injection layer 22. Finally, Al was evaporated on the electron-injection layer 22 to form a cathode 24.

### Example 1

Referring to FIG. 1, a method of fabricating an organic light-emitting diode (device B) of the invention is provided. First, an ITO anode 12 was provided on a substrate. The anode 12 was then treated with UV ozone. Next, copper phthalocyanine was evaporated on the ITO anode 12 to form a hole-injection layer 14. Next, NPB was evaporated on the hole-injection layer 14 to form a hole-transporting layer 16. A green emitting layer 18 was then evaporated on the hole-transporting layer 16. Next, MAND and CsF were co-evaporated on the emitting layer 18 to form an electron-transporting layer 20. The volume ratio of MADN and CsF is 0.8:0.2. Next, LiF was evaporated on the electron-transporting layer 20 to form an electron-injection layer 22. Finally, Al was evaporated on the electron-injection layer 22 to form a cathode 24.

### Comparative Example 2

Referring to FIG. 1, a related method of fabricating an organic light-emitting diode (device C) is disclosed in the following. First, an ITO anode 12 was provided on a substrate. The anode 12 was then treated with UV ozone. Next, copper phthalocyanine was evaporated on the ITO anode 12 to form a hole-injection layer 14. Next, NPB was evaporated on the hole-injection layer 14 to form a hole-transporting layer 16. A red emitting layer 18 was then evaporated on the hole-transporting layer 16. Next, tris(8-hydroxyquinoline)aluminum(III) (Alq₃) was evaporated on the emitting layer 18 to form an electron-transporting layer 20. Next, LiF was evaporated on the electron-transporting layer 20 to form an electron-injection layer 22. Finally, Al was evaporated on the electron-injection layer 22 to'form a cathode 24.

### Comparative Example 3

Referring to FIG. 1, a related method of fabricating an organic light-emitting diode (device D) is disclosed in the following. First, an ITO anode 12 was provided on a substrate. The anode 12 was then treated with UV ozone. Next, copper phthalocyanine was, evaporated on the ITO anode 12 to form a hole-injection layer 14. Next, NPB was evaporated on the hole-injection layer 14 to form a hole-transporting layer 16. A blue emitting layer 18 was then evaporated on the hole-transporting layer 16. Next, tris(8-hydroxyquinoline)aluminum(III) (Alq₃) was evaporated on the emitting layer 18 to form an electron-transporting layer 20. Next, LiF was evaporated on the electron-transporting layer 20 to form an electron-injection layer 22. Finally, Al was evaporated on the electron-injection layer 22 to form a cathode 24.

### Example 2

Referring to FIG. 1, a method of fabricating an organic light-emitting diode (device E) of the invention is provided. First, an ITO anode 12 was provided on a substrate. The anode 12 was then treated with. UV ozone. Next, copper phthalocyanine was evaporated on the ITO anode 12 to form a hole-injection layer 14. Next, NPB was evaporated on the hole-injection layer 14 to form a hole-transporting layer 16. A red emitting layer 18 was then evaporated on the hole-transporting layer 16. Next, MAND and CsF were co-evaporated on the emitting layer 18 to form an electron-transporting layer 20. The volume ratio of MADN and CsF is 0.8:0.2. Next, LiF was evaporated on the electron-transporting layer 20 to form an electron-injection layer 22. Finally, Al was evaporated on the electron-injection layer 22 to form a cathode 24.

### Example 3

Referring to FIG. 1, a method of fabricating an organic light-emitting diode (device F) of the invention is provided. First, an ITO anode 12 was provided on a substrate. The anode 12 was then treated with UV ozone. Next, copper phthalocyanine was evaporated on the ITO anode 12 to form a hole-injection layer 14. Next, NPB was evaporated on the hole-injection layer 14 to form a hole-transporting layer 16. A blue emitting layer 18 was then evaporated on the hole-transporting layer 16. Next, MAND and CsF were co-evaporated on the emitting layer 18 to form an electron-transporting layer 20. The volume ratio of MADN and CsF is 0.8:0.2. Next, LiF was evaporated on the electron-transporting layer 20 to form an electron-injection layer 22. Finally, Al was evaporated on the electron-injection layer 22 to form a cathode 24.

The performance of the devices is cited in TABLE 1.

| | Operating | Efficiency | Efficiency |
|---|---|---|---|
| device | voltage | (cd/A) | (lm/W) |
| A | 6.4 | 9.8 | 4.8 |
| B | 5.8 | 11.6 | 6.3 |
| C | 6.6 | 2.7 | 1.3 |
| D | 5.9 | 5.0 | 2.6 |
| E | 4.6 | 3.6 | 2.5 |
| F | 5.5 | 5.1 | 2.9 |

The results of Table 1 indicate that the devices B, E, and F provided by the invention have lower operating voltage and higher luminescent efficiency than the related devices A, C, and D.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A photoelectric device, comprising:
a set of electrodes having at least two electrodes; and
an electron-transporting layer disposed between the set of electrodes, wherein the electron-transporting layer comprises an organic bipolar compound having electron/hole mobility exceeding 10⁻⁷ cm²v⁻¹s⁻¹ and a metal-containing material.

2. The photoelectric device as claimed in claim 1, wherein the organic bipolar compound and the metal-containing material have a volume ratio of about 0.5:99.5 to 99.5:0.5.

3. The photoelectric device as claimed in claim 1, wherein the organic bipolar compound and the metal-containing material have a volume ratio of about 80:20 to 50:50.

4. The photoelectric device as claimed in claim 1, wherein the organic bipolar compound is selected from the group consisting of anthracene derivative, fluorene derivative, spirofluorene derivative, pyrene derivative, oligomer, and a combination thereof.

5. The photoelectric device as claimed in claim 4, wherein the anthracene derivative comprises 9,10-di-(2-naphthyl)anthracene (ADN), 2-(t-butyl)-9,10-di(2-naphthyl)anthracene (TBADN), or 2-methyl-9,10-di(2-naphthyl)anthracene (MADN).

6. The photoelectric device as claimed in claim 1, wherein the metal-containing material is selected from the group consisting of metal, inorganic metal salt, organic metal salt, and a combination thereof.

7. The photoelectric device as claimed in claim 6, wherein the metal is selected from the group consisting of alkali metal, alkaline-earth metal, and a combination thereof.

8. The photoelectric device as claimed in claim 6, wherein the inorganic metal salt has a cation selected from the group consisting of Li⁺, Na⁺, K⁺, Cs⁺, Mg²⁺, Ca²⁺, Ba²⁺, and a combination thereof.

9. The photoelectric device as claimed in claim 6, wherein the inorganic metal salt has an anion selected from the group consisting of O²⁻, F⁻, Cl⁻, Br⁻, I⁻, NO₃⁻, and a combination thereof.

10. The photoelectric device as claimed in claim 6, wherein the organic metal salt has a cation selected from the group consisting of Li⁺, Na⁺, K⁺, Cs+, Mg²⁺, Ca²⁺, Ba²⁺, and a combination thereof.

11. The photoelectric device as claimed in claim 6, wherein the organic metal salt has an anion selected from the group consisting of aliphatic having carbon atoms less than 30, aromatic organic anion having carbon atoms less than 30, CO₃²⁺, CH₃COO⁻, and a combination thereof.

12. The photoelectric device as claimed in claim 1, further comprising an emitting layer, wherein the set of electrodes comprise a cathode and an anode, and the emitting layer is disposed between the anode and the electron-transporting layer.

13. The photoelectric device as claimed in claim 12, wherein the cathode comprises metal, transparent oxide, or a combination thereof.

14. The photoelectric device as claimed in claim 12, wherein the anode comprises metal, transparent oxide, or a combination thereof.

15. The photoelectric device as claimed in claim 12, wherein the emitting layer comprises fluorescent emitter, phosphorescent emitter, or a combination thereof.

16. The photoelectric device as claimed in claim 1, further comprising a photoelectric conversion layer disposed between the set of electrodes.

17. The photoelectric device as claimed in claim 1, further comprising an organic semiconductor layer, wherein the set of electrodes comprise a gate and a source/drain, and the organic semiconductor layer is disposed between the gate and the source/drain.
